(19) United States
(12) Patent Application Publication
(10) Pub. No.: US 2020/0040981 A1
(43) Pub. Date: Feb. 6, 2020

(54) MULTIPLE CONTACT-POINT FLEXIBLE BEARING APPLICABLE TO A HARMONIC DRIVE

(71) Applicant: SHANGHAI F&S BEARING TECH CO., LTD., Shanghai (CN)

(72) Inventors: Lianchun ZHAO, Shanghai (CN); Sicheng ZHAO, Shanghai (CN); Shuying CHEN, Shanghai (CN)

(21) Appl. No.: 16/338,421

(22) PCT Filed: Dec. 20, 2016
(86) PCT No.: PCT/CN2016/111109

§ 371 Date: Mar. 29, 2019

(30) Foreign Application Priority Data
Sep. 29, 2016 (CN) 201610871353.8
Sep. 29, 2016 (CN) 201621098828.6

(51) Int. Cl. F16H 57/021; F16C 23/08; F16C 33/58; F16H 49/00

(52) U.S. Cl. CPC F16H 57/021; F16C 23/082; F16C 33/583; F16H 2049/003; F16C 2204/60; F16C 2206/40; F16H 49/001

(57) ABSTRACT

A multiple contact-point flexible bearing applicable to harmonic drive has three contact-point flexible ball bearing, four contact-point flexible ball bearing and line contact flexible roller bearing. Single rolling element has two or two more contact points with the outer ring raceway, i.e. outer ring—flexspline interference fit component. Deformation accuracy of outer ring—flexspline interference fit component and teeth meshing accuracy of flexible and rigid wheels are improved so unnecessary additional deformation is reduced and even avoided. Contact stress between rolling element and raceway is reduced. Slip of rolling element is controlled. Quality and technical advantages such as bearing assembly conditions and lubrication conditions in operation are enhanced. Eventually, operating accuracy and service life of the flexible bearing, flexspline even the whole harmonic drive are improved, which means a lot in practical engineering.

### BACKGROUND OF THE INVENTION

### Field of the Invention

The present invention relates to a certain field of rolling bearing technology, and more particularly to a multiple contact-point flexible bearing applicable to a harmonic drive and a flexspline gear tooth in low additional deformation with wave generator—flexspline component employing the same.

### Description of the Prior Art

Harmonic gear reducer (hereinafter referred to as harmonic drive) is a kind of advanced and sophisticated reducer. Since it is characterized by several outstanding advantages, comprising small size, light weight, little backlash, high positioning accuracy and high transmission efficiency, it can be widely utilized in precision mechanical field such as industrial robots, high-end vehicles, aviation aerospace, optical instruments, and high-end printing machines. With the development of intelligent manufacturing having industrial robots as its core, harmonic drive along with RV reducers, have received worldwide attention due to its inherent advancements.

A wave generator—flexspline component is a core functional component in the harmonic drive. As shown in FIG. 7, it includes a wave generator and a flexspline. The wave generator comprises a cam type, a roller type and an eccentric disc type. Out of these, the cam type wave generator is the most commonly used one. It includes a cam and a flexible bearing (or so called a harmonic bearing). The cam is designed to have an elliptical cross section (corresponding to double-wave transmission) or a triangular cross section (corresponding to three-wave transmission) according to a variety of requirements of the transmission. The cam and the inner ring of the flexible bearing are interference fit, and the flexspline and the outer ring of the flexible bearing are interference fit. The gear teeth of the flexspline are meshed with the gear teeth of the rigid wheel in the wave generator—flexspline component to achieve a deceleration or acceleration drive.

Regarding the harmonic drive using the flexible bearing, a wall thickness of the ring is only 0.01˜0.025 times of the outer diameter of the bearing. The cam-typed wave generator is taken as an example. When being installed, the inner circular surface of the inner ring of the flexible bearing and the cam contour of the cam-typed wave generator are interference fit. The outer surface of the outer ring of the flexible bearing and the inner hole which is partially corresponding to the gear tooth portion of the flexspline are interference fit. After installation, the inner ring of the bearing is forcibly deformed into a cam contour shape, such as an elliptical shape employing double wave transmission. And thus, the rolling element is accordingly distributed in an elliptical shape, making the outer ring and the flexspline become elliptical as well. When the harmonic drive is in operation, the inner ring—cam interference fit component rotates, which takes the outer ring—flexspline interference fit component to rotate and the positions of the long axis and the short axis of the elliptical shape to change periodically. Therefore, the gear teeth of the flexspline adjacent the end of the elliptical long axis is able to mesh with the gear teeth of the rigid wheel to achieve power output. It can be seen that the flexible bearing is a very special rolling bearing, which is characterized by pretty thin wall thickness, narrow bearing and a very special working mechanism; the wave generator-flexspline is a very special component, and these two can be interference fit. The macroscopic deformation of the gear teeth of the flexspline is determined by the type of the wave generator and the nature of the contact force of the rolling element acting on the outer ring—flexspline interference fit component.

Both the long-term domestic and overseas application practice have shown that flexible bearings and flexspline are the key components in harmonic drives and easily damaged, which often generates precision failure and fatigue failure before other components. The current flexible bearings are single row shallow groove radial ball bearings, the ball has one contact point with the groove raceway of the outer ring (hereinafter, the groove raceway is simply referred as the gouge) and with the gouge of the inner ring, so that the following problems occur: (1) an external force that makes the outer ring—flexspline interference fit component to generate periodic bending deformation is the contact force between the ball and the outer ring gouge, and these forces are configured on one of the infinite cross sections in a width direction of the outer ring of the bearing or in a width direction of the gear tooth of the flexspline. In this case, two problems occur, one is that the contact force required for the predetermined deformation is too large, and the other is that bending deformation of the outer ring and flexspline of the bearing generated along a width direction of the outer ring of the bearing or a width direction of the gear tooth of the flexspline and a distortion deformation in the circumferential direction are inevitable, thereby affecting the meshing accuracy and transmission efficiency of the flexspline and the rigid wheel. (2) The bearing has extremely low stiffness in the axial and angular directions. Once the external load shows axial and angular components, the bearing ring and the ball will generate the deformation and displacement which is not required for the non-flexible bearing functions along these two directions, thereby reducing transmission efficiency and transmission accuracy of the harmonic drive. (3) The gouge has insufficient constraint on the ball, and a great amount of slip component is generated during the ball movement, thereby causing scratch of the bearing working surface and deterioration of the bearing precision. As a result, there is indeed an urgent need to develop a new type of flexible bearing having its rolling element being contacted with the raceway of the outer ring via non-single contact points to overcome the above mentioned principled technical and quality limitations of the current flexible bearing and wave generator—flexspline interference fit component. As a result, the transmission precision, precision life and fatigue life of the flexible bearing and even the entire harmonic drive can be effectively improved.

### SUMMARY OF THE INVENTION

One objective of the present invention is to provide a multiple contact-point flexible bearing to overcome certain principle techniques and quality limitations of the single row shallow groove radial ball flexible bearings used in the prior arts. For example, the ball had higher contact stress with the ring gouge, and the axial and angular stiffness of the bearing was too low, which force the outer ring—flexspline interference fit component of the bearing to produce predetermined deformation. Also, the contact force between the ball and the gouge of the outer ring was all applied on one of the cross sections along the bearing or a tooth width of the flexspline, causing additional deformation and thus affecting the transmission accuracy, precision life and fatigue life of the harmonic drive. Another objective of the present invention is to provide a wave generator—flexspline component employing the multiple contact-point flexible bearing so as to prevent bending deformation in a tooth width direction and distortion deformation in a circumferential direction of the flexspline when gear tooth of the flexspline generates predetermined radial deformation. As a result, the transmission accuracy and operating reliability of the harmonic drive are improved.

The objectives of the present invention are achieved through the following technical solutions:

A multiple contact-point flexible bearing applicable to a harmonic drive, comprises an outer ring having thin wall thickness, an inner ring having thin wall thickness, a rolling element embedded in a raceway between the outer ring and the inner ring, and a cage used to separate each the rolling element in a circumferential direction uniformly. It is characterized that, two contact points or line contact is provided between the rolling element and the raceway of the outer ring so as to reduce or avoid additional bending deformation in a width direction of the outer ring and/or additional distortion deformation in a circumferential direction of the outer ring when the outer ring having thin wall thickness generates predetermined radial deformation under a contact force that the rolling element applied to the outer ring.

According to the flexible bearing, it is characterized that, the raceway of the outer ring is a peach-shaped or elliptical arc groove raceway, the raceway of the inner ring is a single circular arc groove raceway, the rolling element is a ball, the ball has two contact points with the groove raceway of the outer ring and has one contact point with the groove raceway of the inner ring, the flexible bearing is a three contact-point flexible ball bearing.

According to the flexible bearing, it is characterized that, both the raceways of the outer ring and the inner ring are peach-shaped or elliptical arc groove raceways, the rolling element is a ball, the ball has two contact points with each of the groove raceway of the outer ring and the groove raceway of the inner ring, and the flexible bearing is a four contact-point flexible ball bearing.

According to the flexible bearing, it is characterized that, both the raceways of the outer ring and inner ring are straight line or crowned curve, the rolling element is a roller, the roller has line contact with the raceways of the outer ring and the inner ring, and the flexible bearing is a line contact flexible roller bearing.

According to the three contact-point flexible ball bearing and four contact-point flexible ball bearing, it is characterized that, the ball is made of bearing steel or engineering ceramic.

According to the three contact-point flexible ball bearing and four contact-point flexible ball bearing, it is characterized that, a contact angle between the ball and the groove raceway varies from 5 to 40 degrees.

According to the line contact flexible roller bearing, it further comprises one of the following structures: an inner ring provided with no rib, an outer ring provided with no rib, both an inner ring and outer ring provided with one rib while each the rib is disposed on opposite side of the bearing.

According to the line contact flexible roller bearing, it is characterized that, the roller is made of bearing steel or engineering ceramic, and the cage is made of engineering plastic materials, sheet steel or steel strip.

According to the line contact flexible roller bearing, it is characterized that, the crowned curve is logarithmic curve, and a protrusion amount is less than 300 micrometers.

A wave generator—flexspline component that a flexspline tooth has low additional deformation applicable to a harmonic drive, comprises a wave generator and a flexspline. When a cam-type wave generator (including a cam and a flexible bearing) is employed, the cam has interference fit with an inner surface of an inner ring of the bearing, and the flexspline has interference fit with an outer surface of an outer ring of the bearing. It is characterized that the flexible bearing is the three contact-point flexible ball bearing or the four contact-point flexible ball bearing, or the line contact flexible roller bearing, and the single rolling element in the flexible bearing has two contact points or line contact with an outer ring—flexspline interference fit component so as to reduce bending deformation in a tooth width direction and/or distortion deformation in a circumferential direction of the flexspline when the gear tooth of the flexspline generates predetermined radial deformation.

In order to modify the prior art in which a rolling element only contacts with a single ring via merely one point in a conventional radial ball flexible bearing, a ball bearing, that is, the rolling element used is the ball, is considered first. Accordingly, a cross sectional shape of the gouge of the flexible bearing is modified from a single circular arc gouge to a peach-shaped gouge and a variable curvature gouge formed by double arcs, and the variable curvature gouge preferably can be an elliptical arc gouge. The ball has two contact points with the peach-shaped gouge and the elliptical arc gouge. When a ring (such as an outer ring) has a gouge shape of a peach shape or an elliptical arc shape, and the gouge of the other ring (inner ring) is still a circular arc shape, one ball has total three contact points with the two rings. In such an embodiment, the flexible bearing is a three contact-point flexible bearing. When the gouge shapes of the two rings are both peach shapes or elliptical arc shapes, the flexible bearing under such circumstance is a four contact-point flexible bearing. Since the ball has two contact points with the peach-shaped gouge and the elliptical arc shaped gouge, the contact stress is reduced under the same external load. Since the ball contacts with the peach-shaped gouge and the elliptical arc shaped gouge via a contact angle, which is not zero, the bearing has axial stiffness while having radial stiffness, and the larger the contact angle is, the greater the axial stiffness is. When the raceway of the outer ring is the peach-shaped gouge and the elliptical arc shaped gouge, the contact force between a single ball and the outer ring—flexspline interference fit component have two act points in a direction of the ring width, wherein the two forces have the same radial components, and their axial components are equal in magnitude while in opposite directions. As a result, it helps to prevent additional bending and distortion deformation while the outer ring—flexspline interference fit component generates predetermined radial deformation, thereby improving the transmission accuracy and service life of the drive.

In order to modify the prior art in which the rolling element only contacts with a single ring via merely one point in a conventional radial ball flexible bearing, in addition to considering the ball bearing, the cross sectional shape of the groove raceway in the conventional flexible bearing is modified to be a linear raceway, and the rolling element is modified from the ball to a roller. At this time, the conventional radial ball flexible bearing becomes a roller flexible bearing, in which the roller has line contact with the raceway, that is, having infinite contact points configured along the direction of the contact line. The roller bearing preferably can be a cylindrical roller bearing. In order to avoid stress concentrated at the contact end between the roller and the raceway and to improve operating efficiency of the cylindrical roller bearing, the raceway of the ring is designed as a raceway with convexity or/and the roller is designed with convexity. The contact stress of the single contact pair of the line contact flexible bearing is greatly reduced, and thus has extremely high radial stiffness and angular stiffness. The contact force between a single roller and the outer ring—flexspline interference fit component have infinite act points in a direction of the ring width, and the contact force is the distribution force having its width equal to a length of the roller. It helps a lot to achieve predetermined deformation of the outer ring—flexspline interference fit component and prevent the unexpected bending and distortion deformation from occurring. As a result, the deformation accuracy of the outer ring—flexspline interference fit component is highly improved, thereby significantly enhance the transmission accuracy and service life of the drive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 shows a cross sectional view of a flexible bearing in a conventional art.

FIG. 2 shows a schematic diagram of an outer ring—flexspline interference fit component having a single force act point.

FIG. 3 shows a schematic diagram of an outer ring—flexspline interference fit component having two force act points.

FIG. 4 shows a schematic diagram of an outer ring—flexspline interference fit component having infinite force act points.

FIG. 5A shows a schematic view of a ball along with a groove raceway in a three contact-point (one at the inner groove and two at the outer groove) flexible ball bearing.

FIG. 5B shows a schematic view of a ball along with a groove raceway in a four contact-point (two at the inner groove and two at the outer groove) flexible ball bearing.

FIG. 6A shows a schematic view of a roller having infinite contact points with line raceway and inner ring having no ribs in accordance with the flexible roller bearing.

FIG. 6B shows a schematic view of a roller having infinite contact points with line raceway and outer ring having no ribs in accordance with the flexible roller bearing.

FIG. 6C shows a schematic view of a roller having infinite contact points with line raceway and each of the inner ring and outer ring has single rib on opposite sides in accordance with the flexible roller bearing.

FIG. 7 shows a schematic diagram showing the relative positions of the wave generator, the flexspline and the rigid wheel in the harmonic drive.

FIG. 8 shows a flexspline tooth in low additional deformation with the wave generator—flexspline component.

### DESCRIPTION OF THE PREFERRED EMBODIMENTS

The reference numbers shown in the figures are explained.

FIG. 1 shows a cross sectional view of a flexible bearing in a conventional art, which is a radial ball bearing structure, 11 is an outer ring, 12 is an inner ring, 13 is a ball, 14 is a cage, and each of the outer ring 11 and the inner ring 12 is a type of single circular groove raceway. One ball has only one contact point (the black dot shown in the figure) with each of them, and has two contact points with the two rings.

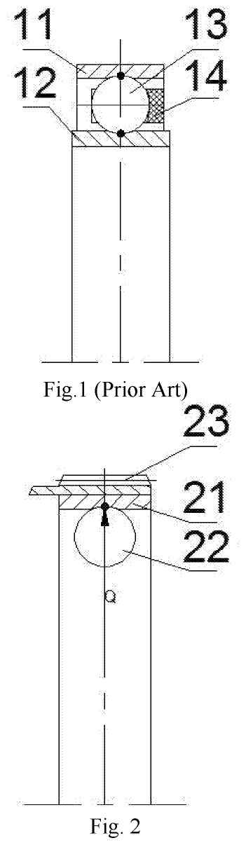

FIG. 2 shows a schematic diagram of an outer ring—flexspline interference fit component having a single force act point, 21 is an outer ring of a type of single circular groove raceway of a current flexible bearing, the rolling element is the ball 22, 23 is the flexspline, and the outer ring 21 and the flexspline 23 are interference fit. One ball has only one contact point (the black dot shown in the figure) with the gouge of the outer ring, so the force that one ball applied to the outer ring—flexspline interference fit component is the concentrated force Q, and its act point is at the bottom of the gouge.

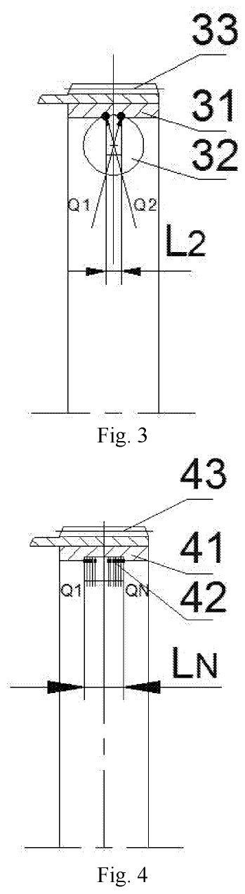

FIG. 3 shows a schematic diagram of an outer ring—flexspline interference fit component having two force act points, 31 is the outer ring of the flexible bearing of the present invention, which is a peach-shaped or elliptical arc groove raceway, the rolling element is a ball 32, and 33 is a flexspline. The outer ring 31 and the flexspline 33 are interference fit. One ball has two contact points (the black dots shown in the figure) with the gouge of the outer ring, and the two contact points are symmetrically distributed on both sides of the gouge bottom, and the contact angles of the two contact points are equal. Thus, the force that one ball applied to the outer ring—flexspline interference fit component comprises the two forces Q₁ and Q₂, and the act points of the two forces along the axial direction of the interference fit component are at a distance of L₂. L₂ is proportional to the magnitude of the contact angle.

FIG. 4 shows a schematic diagram of an outer ring—flexspline interference fit component having infinite force act points, 41 is the outer ring of the flexible bearing of the present invention, which is a straight line or a crowned curve, and the rolling element is a roller 42, 43 is the flexspline, the outer ring 41 and the flexspline 43 are interference fit. One roller has infinite contact points with the gouge of the outer ring, so the force that one roller applied to the outer ring—flexspline interference fit component is the distribution forces, comprising Q₁, Q₂, . . . , Q_{N-1}, Q_{N} (where N is infinite), and the distribution forces along the axial direction of the interference fit component are at a distance of L_{N}, L_{N}>L₂.

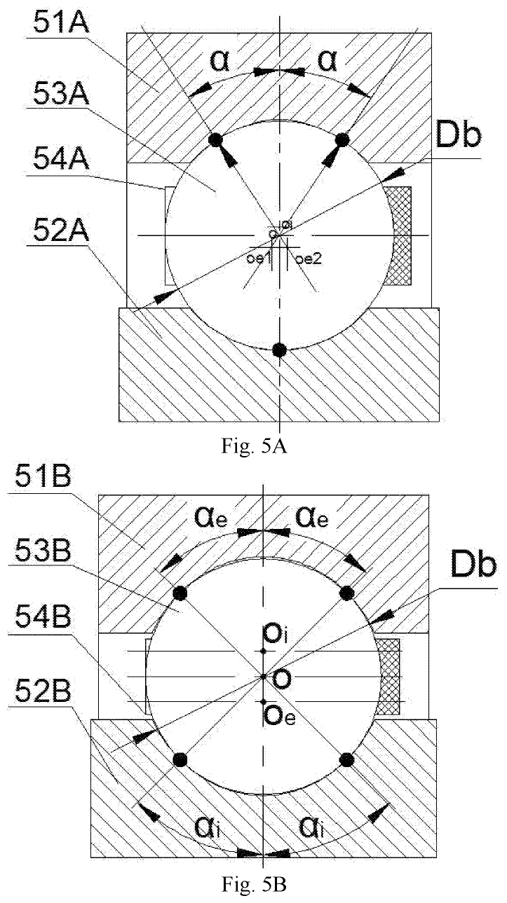

FIG. 5A shows a schematic view of a ball along with a groove raceway in a three contact-point (one at the inner groove and two at the outer groove) flexible ball bearing. 51A is an outer ring of the flexible bearing of the present invention, 52A is an inner ring, 53A is a ball, and 54A is a cage. The outer ring is a peach-shaped gouge composed of two semi-circular arcs. The centers of the two semi-circular arcs are Oₑ₁ and Oₑ₂, respectively. The center of the ball is O. The ball has two contact points with the gouge of the outer ring (the black dots shown in the figure), and the contact points are not at the bottom of the gouge, forming a contact angle α; the inner ring is a single circular arc gouge, the center is Oᵢ, the ball has a single contact point with the gouge of the inner ring, and the contact point is at the bottom of the gouge. The contact angle is zero and the ball has total three contact points with the two ring gouges.

FIG. 5B shows a schematic view of a ball along with a groove raceway in a four contact-point (two at the inner groove and two at the outer groove) flexible ball bearing. 51B is an outer ring of the flexible bearing of the present invention, 52B is an inner ring, 53B is a ball, and 54B is a cage. The outer ring is an elliptical arc gouge, and the ellipse center where the elliptical arc is located is Oₑ. The curvature of each point on the gouge varies with position. The center of the ball is O, and there are two contact points with the gouge of the outer ring (the black dots shown in the figure). The contact points are not at the bottom of the gouge, forming a contact angle αₑ; the inner ring is also an elliptical arc gouge, the elliptical center where the elliptical arc is located is Oᵢ, and the curvature of each point on the gouge varies with position. The ball has two contact points with the gouge of the inner ring, and the contact points are not at the bottom of the gouge, forming a contact angle αᵢ. The ball has total four contact points with the two ring gouges.

In FIG. 5A and FIG. 5B, in order to show the center position of the curvature of each contact surface, only the shape of the actual cross section of the bearing is drawn, and the center line position of the bearing is not shown.

In FIG. 5A and FIG. 5B, the contact force of the rolling element with the raceway of the outer ring is as shown in FIG. 3.

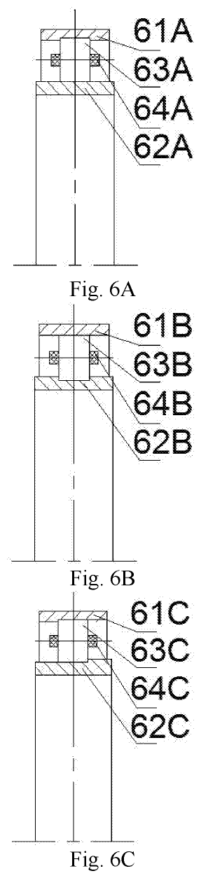

FIG. 6A shows a schematic view of a roller contacted with line raceway via infinite contact points and inner ring having no ribs in accordance with the flexible roller bearing. 61A is the outer ring of the flexible bearing of the present invention, 62A is the inner ring, 63A is the roller, and 64A is the cage. The outer ring is a linear raceway without convexity or convexity, having double ribs. The roller forms contact with the raceway of the outer ring over the entire length of the roller, having infinite contact points; the inner ring is a linear raceway without convexity or convexity, having no ribs. The roller forms contact with the raceway of the inner ring over the entire length of the roller, having infinite contact points. In the whole bearing, since the inner ring is provided with no rib, the inner ring can be detachable.

The reference numbers in FIG. 6B and FIG. 6C are consistent with those in FIG. 6A. When one of the rings is provided with a single rib or no rib, the ring can be a detachable ring, which is very convenient for disassembly and installation of the bearing. The axial limit of the ring is accomplished by a harmonic drive wave generator or a shoulder, collar on the flexspline or the like.

Among FIG. 6A to FIG. 6C, what these flexible roller bearings have in common is that the contact force of the rolling element with the raceway of the outer ring is distributed and shown as in FIG. 4.

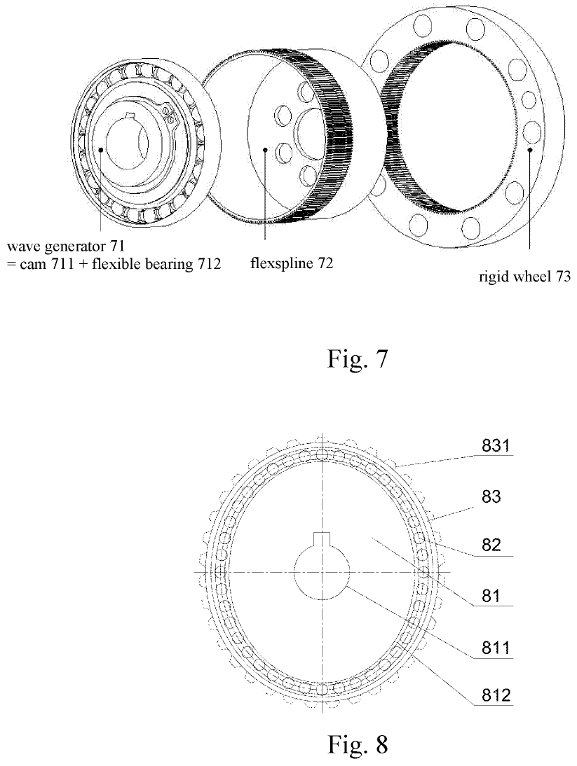

FIG. 7 shows a schematic diagram showing the relative positions of the wave generator 71, the flexspline 72 and the rigid wheel 73 in the harmonic drive. The figure shows a cam-type wave generator, which includes a cam 711 and a flexible bearing 712. The outer surface of the cam with a certain geometric contour (such as ellipse) is interference fit with the inner circular surface of the inner ring of the flexible bearing, and the outer surface of the wave generator, that is, the outer surface of the outer ring of the flexible bearing is interference fit with the inner hole which is partially corresponding to the gear tooth portion of the flexspline. The component in which the wave generator and the flexspline are interference fit is called a wave generator—flexspline component. The external teeth of the flexspline mesh with the internal teeth of the rigid wheel to achieve power transmission and speed variation. The wave generator 71, the flexspline 72 and the rigid wheel 73 have a common central axis.

FIG. 8 shows a flexspline gear tooth in low additional deformation with the wave generator—flexspline component, in which a double wave drive cam wave generator is shown. 81 is a cam with an elliptical outline, 82 is a flexible bearing, and 83 is a flexspline, wherein 811 is the mounting inner hole surface of the cam, 812 is the elliptical outline of the cam, and 831 is the gear tooth of the flexspline.

The present invention will be described in details with reference made to the accompanying drawings as follows.

### Embodiment 1, the Three Contact-Point Flexible Ball Bearing as Shown in FIG. 5A

In FIG. 5A, 51A is an outer ring of the flexible bearing, 52A is the inner ring, 53A is the ball, and 54A is the cage. The ball 53A is embedded in the raceway between the outer ring shown in 51A and the inner ring shown in 52A, and is circumferentially separated by the cage shown in 54A. The outer ring 51A is a peach-shaped gouge composed of two semi-circular arcs. The centers of the two semi-circular arcs are Oₑ₁ and Oₑ₂, respectively. The center of the ball 53A is O. The ball 53A has two contact points with the gouge of the outer ring 51A, and the contact points are not at the bottom of the gouge, forming a contact angle α. The inner ring 52A is a single circular arc gouge, the center is Oᵢ, the ball 53A has a single contact point with the gouge of the inner ring 52A, and the contact point is at the bottom of the gouge. The contact angle is zero and the ball 53A has total three contact points with the two ring gouges.

The outer ring 51A and the inner ring 52A are made of bearing steel, the ball 53A is made of bearing steel or tantalum nitride ceramic, and the cage 54A is made of engineering plastic materials. The contact angle α varies from 5 to 40 degrees. It is apparent that the ball 53A does not contact with the bottom of the gouge of the outer ring 51A (i.e., a tip of the peach-shaped gouge), but at a distance. The greater the magnitude of the contact angle is, the further such distance will be, meaning that a wall thickness between the gouge of the outer ring and the outer surface of the outer ring is thinner. As a result, when the wall thickness of the outer ring 51A of the flexible bearing is thinner, the contact angle α should be selected to be smaller, and the distance between the two contact points is smaller, which indicates a narrower range of the force applied to the ring.

The three contact-point flexible ball bearing and the act force that the rolling element applied to the outer ring—flexspline interference fit component are as shown in FIG. 3.

### Embodiment 2, the Four Contact-Point Flexible Ball Bearing as Shown in FIG. 5B

In FIG. 5B, 51B is an outer ring of the flexible bearing, 52B is the inner ring, 53B is the ball, and 54B is the cage. The ball 53B is embedded in the raceway between the outer ring shown in 51B and the inner ring shown in 52B, and is circumferentially separated by the cage shown in 54B. The outer ring 51B is an elliptical arc gouge, and the ellipse center where the elliptical arc is located is Oₑ. The curvature of each point on the gouge varies with position. The center of the ball 53B is O, and there are two contact points with the gouge of the outer ring 51B. The contact points are not at the bottom of the gouge, forming a contact angle αₑ. The inner ring 52B is also an elliptical arc gouge, the elliptical center where the elliptical arc is located is Oᵢ, and the curvature of each point on the gouge varies with position. The ball 53B has two contact points with the gouge of the inner ring 52B, and the contact points are not at the bottom of the gouge, forming a contact angle αᵢ. The ball 53B has total four contact points with the two ring gouges.

The outer ring 51B and the inner ring 52B are made of bearing steel, the ball 53B is made of bearing steel or tantalum nitride ceramic, and the cage 54B is made of engineering plastic materials. The contact angle α varies from 5 to 40 degrees. It is apparent that the ball 53B does not contact with the bottom of the gouges of the outer ring 51B and the inner ring 52B, but at a distance. The greater the magnitude of the contact angle is, the further such distance will be, meaning that a wall thickness between the gouge of the outer ring and the outer surface of the outer ring and between the gouge of the inner ring and the inner circular surface of the inner ring will be thinner. As a result, when the wall thickness of the ring of the flexible bearing is thinner, the contact angle α of the ball with the gouge of the ring should be selected to be smaller.

The elliptical arc gouge is the gouge which is a small part of an ellipse. The long axis of the elliptical arc gouge of the outer ring is located on the line connecting the center of the ball and the bottom of the gouge of the outer ring. The long axis of the elliptical arc gouge of the inner ring is located on the line connecting the center of the ball and the bottom of the gouge of the inner ring. In FIG. 5B, Oₑ indicates the elliptical center where the elliptical arc of the gouge of the outer ring is located, and Oᵢ indicates the elliptical center where the elliptical arc of the gouge of the inner ring is located.

The four contact-point flexible ball bearing and the act force that the rolling element applied to the outer ring—flexspline interference fit component are as shown in FIG. 3.

### Embodiment 3, a Roller has Infinite Contact Points with Line Raceway and Inner Ring Having No Ribs in Accordance with the Flexible Roller Bearing as Shown in FIG. 6A

In FIG. 6A, 61A is the outer ring, 62A is the inner ring, 63A is the roller embedded in the raceway between the outer ring and the inner ring, and 64A is the cage which is used to separate each roller 63A in the circumferential direction of the bearing. The outer ring 61A is provided with double ribs. The inner ring 62A is provided with no rib. The raceways of the outer ring 61A and the inner ring 62A, and busbar of the roller 63A are straight. The roller 63A forms contact with the raceways of the outer ring 61A and the inner ring 62A over the entire length of the roller 63A, having infinite contact points. In view of the flexible bearing, since the inner ring 62A is provided with no rib, the inner ring 62A can be a detachable inner ring.

The outer ring 61A and the inner ring 62A of the flexible roller bearing are made of bearing steel, the roller 63A is made of bearing steel or engineering ceramic, and the cage 64A is made of plastic or metal stamping holder.

After the bearing is installed, the two ribs of the outer ring limit the axial displacement or movement of the roller and the cage.

The line contact flexible roller bearing and the act force that the rolling element applied to the outer ring—flexspline interference fit component are as shown in FIG. 4.

### Embodiment 4, a Roller has Infinite Contact Points with Line Raceway and Inner Ring and Outer Ring Each Having Single Rib on Opposite Sides in Accordance with the Flexible Roller Bearing as Shown in FIG. 6C

In FIG. 6C, 61C is the outer ring, 62C is the inner ring, 63C is the roller embedded in the raceways between the outer ring and the inner ring, and 64C is the cage which is used to separate each roller 63C in the circumferential direction of the bearing. Each of the outer ring 61C and the inner ring 62C is provided with one rib. Nevertheless, the two ribs each on the ring are not on the same side of the bearing. The raceways of the outer ring 61C and the inner ring 62C, and busbar of the roller 63C are logarithmic curve. The roller 63C forms line contact with the raceways of the outer ring 61C and the inner ring 62C over the entire length of the roller 63C, having infinite contact points. In view of the flexible bearing, since each of the outer ring 61C and the inner ring 62C is provided with one rib, both the two rings are detachable.

The outer ring 61C and the inner ring 62C of the flexible roller bearing are made of bearing steel, the roller 63C is made of bearing steel or engineering ceramic, and the cage 64C is made of plastic or metal stamping holder.

After the bearing is installed, the two ribs each on the ring which are not on the same side of the bearing limit the axial displacement or movement of the roller and the cage.

The line contact flexible roller bearing and the act force that the rolling element applied to the outer ring—flexspline interference fit component are as shown in FIG. 4.

### Embodiment 5, a Flexspline Gear Tooth in Low Additional Deformation with the Wave Generator—Flexspline Component as Shown in FIG. 8

The wave generator shown in the figure is a double wave drive cam wave generator. 81 is a cam with an elliptical outline, 82 is a flexible bearing, and 83 is a flexspline, wherein 811 is the mounting inner hole surface of the cam, 812 is the elliptical outline of the cam, and 831 is the gear tooth of the flexspline. The interference fit of 81 and 82 is the wave generator. And, the component in which the wave generator and the flexspline 83 are interference fit is called a wave generator—flexspline component.

Different from the prior wave generator-flexspline component adopting a single row shallow groove radial ball flexible bearing, the wave generator—flexspline component in the embodiment of the present invention employs the multiple contact-point flexible ball bearing 82 having the rolling element and the raceway of the outer ring as described in Embodiments 1 to 4. The outer elliptical surface of the cam 81 is interference fit with the inner circular surface of the inner ring of the flexible bearing 82. The cross sectional shape of the flexible bearing 82 was circular before assembly and is forced to become elliptical after assembly. The inner circular surface of the flexspline 83 is interference fit with the outer elliptical surface of the outer ring of the flexible bearing 82, and the cross sectional shape of the flexspline 83 was also circular before assembly and is forced to become elliptical after assembly.

Since the wave generator—flexspline component in the embodiment employs the multiple contact-point flexible bearing, and two (three contact-point flexible ball bearing, four contact-point flexible ball bearing) or infinite (line contact flexible roller bearing) contact points between single rolling element and the flexspline—outer ring interference fit component, when the harmonic drive is in operation, in addition to the gear tooth 831 of the flexspline 83 generating predetermined radial deformation in the plane of the figure, additional bending deformation in the direction of the tooth width or additional distortion deformation in the circumferential direction of the gear tooth of the flexspline is controlled, which is a lot less than being compared to the current technology, or not even occurred. Therefore, the transmission accuracy, transmission efficiency and service reliability of the harmonic drive is greatly improved.

The above mentioned harmonic drive adopts multiple contact-point flexible bearing including three contact-point flexible ball bearing, four contact-point flexible ball bearing, and line contact flexible roller bearing; and two or infinite contact points between single rolling element and the raceway of the outer ring, i.e. the outer ring—flexspline interference fit component. Compared with the prior art, which comprises only one contact point, the present invention is characterized by many technical and quality advantages. For better understanding, the comparison results between the present invention and the prior art are listed in the following table.

| | Technical quality performance | | | |
|---|---|---|---|---|
| | Prior art | The present invention | | |
| | Flexible bearing type | | | |
| | Radial ball | Three contact | Four contact | Line contact |
| | bearing | points ball bearing | points ball bearing | roller bearing |
| Rolling element type | ball | ball | ball | roller |
| Number of contact point | one | two | two | infinite |
| between single rolling | | | | |
| element and the outer | | | | |
| ring raceway | | | | |
| Contact stress level of | Highest | Middle | Middle | Lowest |
| rolling element with the | | | | |
| outer ring raceway | | | | |
| Number of contact point | one | two | two | infinite |
| between single rolling | | | | |
| element and the outer | | | | |
| ring - flexspline | | | | |
| interference fit | | | | |
| component | | | | |
| Type of force a single | Concentrated | Concentrated | Concentrated | Distribution |
| rolling element applied | force upon one | force upon two | force upon two | force upon |
| to the outer ring - | act point | act points | act points | infinite act |
| flexspline interference fit | | | | points |
| component | | | | |
| Bending deformation in | Greatest | less | less | least |
| the direction of its center | | | | |
| axis of the outer ring - | | | | |
| flexspline interference fit | | | | |
| component | | | | |
| Bending deformation in | Greatest | less | less | least |
| the direction of the tooth | | | | |
| width of the gear tooth | | | | |
| of the flexspline | | | | |
| Meshing accuracy of the | Lowest | Higher | Higher | Highest |
| gear tooth of the flexible | | | | |
| and rigid wheel | | | | |
| Transmission accuracy | Lowest | Higher | Higher | Highest |
| of the harmonic drive | | | | |
| The flexible bearing ring | Difficult, ring | Difficult, ring | Difficult, ring | Easy, no ring |
| and the rolling element | deformation | deformation | deformation | deformation |
| are intermeshed | needed | needed | needed | needed |
| Scratch risk of the | Extremely high | Extremely high | Extremely high | Zero |
| flexible bearing ring and | | | | |
| the rolling element while | | | | |
| intermeshed | | | | |
| Distance between the | Zero | Tiny | Tiny | Zero |
| rolling element and | | | | |
| bottom of the ring | | | | |
| raceway | | | | |
| Oil storage function at | None | Yes | Yes | None |
| bottom of the ring | | | | |
| raceway | | | | |
| Controllability of the | Bad | Good | Good | Good |
| rolling element while the | | | | |
| outer ring - flexspline | | | | |
| interference fit | | | | |
| component in periodic | | | | |
| deformation | | | | |
| Slip risk of the rolling | High | Low | Low | Low |
| element while the outer | | | | |
| ring - flexspline | | | | |
| interference fit | | | | |
| component in periodic | | | | |
| deformation | | | | |
| Fatigue life of the | Least | Higher | Higher | Highest |
| flexible bearing | | | | |

By employing the multiple contact-point flexible bearing of the present invention, the wave generator—flexspline component is advantageous of less additional deformation, high accuracy of transmission, and so on.

A cam-type wave generator is taken as an example. Assume that the cross sectional shape of the outer surface of the cam is elliptical, when the flexible bearing passes the interference fit of the inner circular surface with the cam, the interference fit of the outer surface with the flexspline, and the cam and the flexspline are integrated. After integration, the cross section of the inner ring of the bearing, the distribution shape of the center of each rolling element in the cross section, the cross section of the outer ring of the bearing, and the cross section of the flexspline are all forced to become elliptical shapes. In order to improve the meshing precision of the gear tooth of the flexspline and the rigid wheel, thereby increasing the transmission accuracy of the harmonic drive, it is expected that the shape of each cross section is the same in an effective meshing length of the gear tooth of the flexspline (and the gear tooth of the rigid wheel), that is a same ellipse, indicating that, there is no additional bending deformation along the width direction of the outer ring—flexspline interference fit component in the bearing, and no distortion deformation along the circumferential direction of the outer ring—flexspline interference fit component in the bearing. However, the conventional flexible bearing uses a regular radical ball structure, and a concentrated force that the single rolling element applied to the outer ring—flexspline interference fit component is on one point (at bottom of the gouge of the outer ring), so the above mentioned additional bending deformation and distortion deformation cannot be avoided, which brought the inevitable negative impact on the transmission accuracy as well as service life of the harmonic drive. The present invention employs a three contact-point flexible ball bearing and a four contact-point flexible ball bearing, in which single rolling element can have two contact points with the raceway of the outer ring, generating two concentrated forces. These two contact points are configured at a distance along the axial direction of the outer ring—flexspline interference fit component of the bearing, so that the above mentioned bending deformation and distortion can be effectively reduced; The present invention employs a linear contact flexible roller bearing, in which single rolling element can have infinite contact points with the raceway of the outer ring and the contact force is the distribution force along the entire length of the roller. As a result, it helps to significantly reduce or even completely avoid the above mentioned bending and distortion deformation.

There exist a lot of differences between the three contact-point flexible ball bearing, four contact-point flexible ball bearing of the present invention and the three contact-point ball bearing, four contact-point ball bearing in the prior arts. For example, the prior arts adopt three contact-point ball bearing and four contact-point ball bearing mainly because they have good stiffness in both the radial direction and the axial direction of the bearing (the axial stiffness of a regular radial ball bearing is usually very low). However, the three contact-point flexible ball bearing and four contact-point flexible ball bearing of the present invention are employed for increasing the number of contact points of the ball with the gouge in the axial direction of the bearing as well as the distance between the force act points, thereby improving the predetermined deformation accuracy of the outer ring—flexspline interference fit component. In addition, for example, a wall thickness of the ring of the flexible bearing is very thin having its gouge pretty shallow and the wall thickness from its gouge bottom to the outer surface is also very thin. Therefore, the contact angle of the bearing sometimes must be designed smaller, such as 20 degrees, while the three contact-point and four contact-point ball bearing in the prior arts usually take contact angles larger than 35 degrees.

There also exist a lot of differences between the line contact flexible roller bearing of the present invention and the conventional roller bearing in the prior arts. For example, the prior art simply adopts the roller bearing for improving the radial bearing capacity and radial stiffness of the bearing, which is different from the present invention. The present invention adopts a roller bearing mainly because the roller is able to have infinite contact points with the outer ring—flexspline interference fit component in the axial direction, generating distribution forces along the entire length of the roller. And thus, it helps to significantly improve the predetermined deformation accuracy of the outer ring—flexspline interference fit component. For example, a wall thickness of the flexible bearing is not only thin but also narrow. When a ring is provided with double ribs, the strength of the rib may be pretty critical. Based on that, each of the outer ring and the inner ring of the present invention is provided with single rib but both ribs are disposed on opposite sides of the bearing (shown in FIG. 6C), which is very practical. Furthermore, for example, since the wall thickness of the flexible bearing is not only thin but also narrow, some products must choose to use the cylindrical roller having its aspect ratio (roller length/roller diameter) less than 1, which does not even exist in the current technology, since the minimum length of a current cylindrical roller bearing is equal to its diameter.

Undoubtedly, in addition to better fulfill the functions of the flexible bearing in the harmonic drive, the three contact-point flexible ball bearing, four contact-point flexible ball bearing and line contact flexible roller bearing of the present invention are also characterized by other advantages of the three contact-point ball bearing, four contact-point ball bearing and the roller bearing, which have been listed in the above table. Due to the above mentioned advantages of multiple contact-point flexible bearings, the wave generator—flexspline component using the multiple contact-point flexible bearings has outstanding advantages of low deformation in the gear tooth of the flexspline as compared with the current wave generator—flexspline component using a single contact-point flexible bearing. It means a lot to the aspect for improving the transmission accuracy, transmission efficiency and working reliability of harmonic drive, and also because industrial robots widely adopt harmonic drive these days, these above mentioned technical quality innovation and progress provide very important practical significances in the intelligent manufacturing area when industrial robots play one of the main symbols.

For what is claimed in the three contact-point flexible ball bearing having one contact point at the outer gouge and two contact points at the inner gouge, since a single ball contacts with the inner gouge via two contact points, it also contributes to control the slip of the ball as well as to improve the operating stability of the bearing.

The above disclosure merely shows a few specific embodiments of the present invention, but the present invention is not limited thereto. It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A multiple contact-point flexible bearing applicable to a harmonic drive, comprising an outer ring having thin wall thickness, an inner ring having thin wall thickness, a rolling element embedded in raceways between the outer ring and the inner ring, and a cage used to separate each the rolling element in a circumferential direction uniformly;
wherein, two contact points or line contact is provided between the rolling element and the raceway of the outer ring so as to reduce or avoid additional bending deformation in a width direction of the outer ring and/or additional distortion deformation in a circumferential direction of the outer ring when the outer ring having thin wall thickness generates predetermined radial deformation under a contact force that the rolling element applied to the outer ring.

2. The flexible bearing according to claim 1, wherein the raceway of the outer ring is a peach-shaped or elliptical arc groove raceway, the raceway of the inner ring is a single circular arc groove raceway, the rolling element is a ball, the ball has two contact points with the groove raceway of the outer ring and one contact point with the groove raceway of the inner ring, the flexible bearing is a three contact-point flexible ball bearing.

3. The flexible bearing according to claim 1, wherein both the raceways of the outer ring and the inner ring are peach-shaped or elliptical arc groove raceways, the rolling element is a ball, the ball has two contact points with both raceways of the outer ring and inner ring, and the flexible bearing is a four contact-point flexible ball bearing.

4. The flexible bearing according to claim 1, wherein both the raceways of the outer ring and inner ring are straight line or crowned curve, the rolling element is a roller, the roller has line contact with the raceways of the outer ring and the inner ring, and the flexible bearing is a line contact flexible roller bearing.

5. The flexible bearing according to claim 2, wherein the ball is made of bearing steel or engineering ceramic.

6. The flexible bearing according to claim 2, wherein a contact angle between the ball and the groove raceway varies from 5 to 40 degrees.

7. The flexible bearing according to claim 4, comprising one of the following structures: an inner ring provided with no rib, an outer ring provided with no rib, both an inner ring and outer ring provided with one rib while each the rib is disposed on opposite side of the bearing.

8. The flexible bearing according to claim 4, wherein the roller is made of bearing steel or engineering ceramic, and the cage is made of engineering plastic materials, sheet steel or steel strip.

9. The flexible bearing according to claim 4, wherein the crowned curve is logarithmic curve, and a protrusion amount is less than 300 micrometers.

10. A wave generator—flexspline component that a flexspline tooth has low additional deformation applicable to a harmonic drive, comprising a wave generator and a flexspline, when a cam-type wave generator including a cam and a flexible bearing is employed, the cam has interference fit with an inner surface of an inner ring of the bearing, and the flexspline has interference fit with an outer surface of an outer ring of the bearing, wherein the flexible bearing is the three contact-point flexible ball bearing according to claim 2, or the four contact-point flexible ball bearing according to claim 3, or the line contact flexible roller bearing according to claim 4, and the single rolling element in the flexible bearing has two contact points or line contact with an outer ring—flexspline interference fit component so as to reduce bending deformation in a tooth width direction and/or distortion deformation in a circumferential direction of the flexspline when the gear tooth of the flexspline generates predetermined radial deformation.

11. The flexible bearing according to claim 3, wherein the ball is made of bearing steel or engineering ceramic.

12. The flexible bearing according to claim 3, wherein a contact angle between the ball and the groove raceway varies from 5 to 40 degrees.
